(19) United States
(12) Patent Application Publication
(10) Pub. No.: US 2011/0249195 A1
(43) Pub. Date: Oct. 13, 2011

(54) DISPLAY DEVICE, AND TELEVISION RECEIVER

(76) Inventor: Osamu Teranuma, Osaka (JP)

(21) Appl. No.: 12/998,914

(22) PCT Filed: Feb. 17, 2010
(86) PCT No.: PCT/JP2010/052309

§ 371 Date: Jun. 15, 2011

(30) Foreign Application Priority Data
May 29, 2009 (JP) 2009131122

(51) Int. Cl. G09G 3/36; H04N 5/66; G09G 5/10

(52) U.S. Cl. 348/730; 345/690; 345/102

(57) ABSTRACT

A liquid crystal display device includes a backlight device and a liquid crystal panel that displays information using illumination light from the backlight device. The liquid crystal display device further includes a power consumption setting portion that sets the target power consumption as set power consumption, and a storage portion that previously stores the power consumption characteristics that indicate the relationship between a video signal and power consumption of the backlight device. The liquid crystal display device also includes a backlight control portion that performs drive control of the backlight device using the input video signal, the set power consumption set by the power consumption setting portion, and the power consumption characteristics stored in the storage portion.

### TECHNICAL FIELD

The present invention relates to a display device including a display portion that displays information such as characters and images, and a television receiver using the display device.

### BACKGROUND ART

In recent years, a display device including a liquid crystal panel as a flat display portion, as typified by a liquid crystal display device, is becoming the mainstream of, e.g., a household television receiver. The liquid crystal panel has many features such as thinness and light weight compared to a conventional Broun tube. Such a liquid crystal display device includes a backlight device and a liquid crystal panel. The backlight device emits light and the liquid crystal panel displays a desired image by serving as a shutter with respect to light from a light source provided in the backlight device. In the television receiver, information such as characters and images contained in video signals of television broadcasting is displayed on the display surface of the liquid crystal panel.

In a conventional liquid crystal display device, as described, e.g., in Patent Document 1 below, it has been proposed to reduce power consumption of the liquid crystal display device by reducing the brightness of the backlight device. Specifically, the conventional liquid crystal display device includes a power saving target function setting means for setting a power saving target period and a power saving target value, and a power consumption amount calculating means for determining a power consumption amount from a start point of the power saving target period. Moreover, the conventional liquid crystal display device includes a backlight brightness reducing means that reduces the brightness of the backlight device when the ratio of the power consumption amount determined by the power consumption amount calculating means to the power saving target value reaches a predetermined level. It has been considered that the conventional liquid crystal display device with this configuration can reduce power consumption.

### PRIOR ART DOCUMENTS

### Patent Documents

Patent Document 1: JP 2008-79076A

### DISCLOSURE OF INVENTION

### Problem to be Solved by the Invention

However, in the above conventional liquid crystal display device, the brightness of the backlight device is forced to be reduced as the ratio of the power consumption amount to the power saving target value reaches a predetermined level. Therefore, the conventional liquid crystal display device can have a problem of making a viewer feel uncomfortable with brightness changes when the power consumption is reduced.

With the foregoing in mind, it is an object of the present invention to provide a display device that can suppress an uncomfortable feeling caused by brightness changes even if the power consumption is reduced, and a television receiver using the display device.

### Means for Solving Problem

To achieve the above object, a display device of the present invention includes a backlight portion and a display portion that displays information using illumination light from the backlight portion. The display device further includes the following: a control portion that receives a video signal from the outside and performs drive control of the backlight portion and the display portion using the input video signal; a power consumption setting portion that sets target power consumption as set power consumption; and a storage portion that previously stores the power consumption characteristics that indicate the relationship between the video signal and power consumption of the backlight portion. The control portion includes a backlight control portion that performs drive control of the backlight portion using the input video signal, the set power consumption set by the power consumption setting portion, and the power consumption characteristics stored in the storage portion.

The display device with the above configuration includes the power consumption setting portion that sets the target power consumption as set power consumption, and the storage portion that previously stores the power consumption characteristics that indicate the relationship between the video signal and the power consumption of the backlight device. Moreover, the control portion includes the backlight control portion that performs drive control of the backlight device using the input video signal, the set power consumption set by the power consumption setting portion, and the power consumption characteristics stored in the storage portion. Thus, unlike the conventional examples, the display device can suppress an uncomfortable feeling caused by brightness changes even if the power consumption is reduced.

In the display device, it is preferable that the backlight control portion includes a brightness determining portion that corrects the power consumption characteristics stored in the storage portion based on the set power consumption set by the power consumption setting portion, and determines brightness of the illumination light using the input video signal and the corrected power consumption characteristics.

In this case, since the brightness determining portion determines the brightness of the illumination light using the input video signal and the power consumption characteristics that have been corrected based on the set power consumption, it is possible to reliably suppress an uncomfortable feeling caused by brightness changes even if the power consumption is reduced.

In the display device, the brightness determining portion may correct the power consumption characteristics stored in the storage portion so that the power consumption of the backlight portion is not more than the set power consumption set by the power consumption setting portion.

In this case, the display device can reduce the power consumption reliably while suppressing an uncomfortable feeling caused by brightness changes.

In the display device, the brightness determining portion may correct the power consumption characteristics stored in the storage portion so that a maximum value of the power consumption of the backlight portion is not more than the set power consumption set by the power consumption setting portion, and each value of the power consumption in the power consumption Characteristics is reduced by a predetermined ratio.

In this case, the display device can reduce the power consumption more reliably while suppressing an uncomfortable feeling caused by brightness changes.

The display device may further include a buffer memory that stores a plurality of frames of video signals. In this display device, the brightness determining portion may use the video signals stored in the buffer memory to correct the power consumption characteristics again, which have been already corrected based on the set power consumption set by the power consumption setting portion, and determine brightness of the illumination light using the input video signal and the twice-corrected power consumption characteristics.

In this case, the brightness can be improved in accordance with the video signals that are actually displayed.

The display device may further include a battery capable of charging and discharging electricity; and a remaining battery level monitoring portion that monitors a remaining amount of the battery and outputs remaining battery level information that indicates the monitored remaining amount of the battery to the outside. In this display device, the control portion may include a power consumption estimating portion that estimates an amount of power consumption for a predetermined time using the predetermined time that is previously set and the set power consumption set by the power consumption setting portion. Moreover, the brightness determining portion may compare the remaining amount of the battery indicated by the remaining battery level information from the remaining battery level monitoring portion and the amount of power consumption estimated by the power consumption estimating portion, and when the comparison shows that the remaining amount of the battery is smaller than the amount of power consumption, the brightness determining portion may correct the power consumption characteristics stored in the storage portion so that the amount of power consumption for the predetermined time is not more than the remaining amount of the battery, and determine brightness of the illumination light using the input video signal and the corrected power consumption characteristics.

In this case, since the brightness of the illumination light is determined using the remaining amount of the battery monitored by the remaining battery level monitoring portion, the display device including the battery can suppress an uncomfortable feeling caused by brightness changes even if the power consumption is reduced.

In the display device, it is preferable that the control portion includes a display control portion that performs drive control of the display portion in accordance with the brightness of the illumination light determined by the brightness determining portion.

In this case, the display quality of the display device can be easily improved.

The display device may further include a memory that previously stores the maximum power consumption of the display portion. In this display device, it is preferable that the brightness determining portion corrects the power consumption characteristics stored in the storage portion based on the set power consumption set by the power consumption setting portion and the maximum power consumption stored in the memory, and determines brightness of the illumination light using the input video signal and the corrected power consumption characteristics.

In this case, an appropriate reduction in power consumption can be more easily achieved.

In the display device, it is preferable that the storage portion previously stores the power consumption characteristics that relate an average picture level of the video signals per frame to the power consumption of the backlight portion, and that the backlight control portion performs drive control of the backlight portion using the average picture level of the input video signals per frame, the set power consumption set by the power consumption setting portion, and the power consumption characteristics stored in the storage portion.

In this case, the drive control of the backlight portion can be properly performed in accordance with the video signal.

A television receiver of the present invention includes any of the above display devices.

The television receiver with the above configuration includes the display device that can suppress an uncomfortable feeling caused by brightness changes even if the power consumption is reduced. Therefore, the television receiver can easily achieve low power consumption, high performance, and excellent display quality.

### Effects of the Invention

The present invention can provide a display device that can suppress an uncomfortable feeling caused by brightness changes even if the power consumption is reduced, and a television receiver using the display device.

### BRIEF DESCRIPTION OF DRAWINGS

FIG. 1 is an exploded perspective view for explaining a television receiver and a liquid crystal display device according to Embodiment 1 of the present invention.

FIG. 2 is a block diagram showing the main configurations of the television receiver and the liquid crystal display device.

FIG. 3 is a block diagram showing a specific configuration of the control portion shown in FIG. 2.

FIG. 4A is a graph showing an example of the power consumption characteristics stored in the storage portion shown in FIG. 3. FIG. 4B is a graph showing a specific correlation example between backlight output and power consumption. FIG. 4C is a graph showing a specific correlation example between an average picture level (APL) and backlight output.

FIG. 5 is a graph showing a specific example of the power consumption characteristics that are corrected by the brightness determining portion shown in FIG. 3.

FIG. 6 is a block diagram showing a specific configuration of a control portion of a liquid crystal display device according to Embodiment 2 of the present invention.

FIG. 7 is a graph showing a specific example of the power consumption characteristics that are corrected by the brightness determining portion shown in FIG. 6.

FIG. 8 is a block diagram showing a specific configuration of a control portion of a liquid crystal display device according to Embodiment 3 of the present invention.

FIG. 9A is a graph showing a specific example of the power consumption characteristics that are corrected by the brightness determining portion shown in FIG. 8. FIG. 9B is a graph showing a specific example of the power consumption characteristics that are corrected again by the brightness determining portion shown in FIG. 8.

FIG. 10 is a block diagram showing the main configuration of a television receiver according to Embodiment 4 of the present invention.

FIG. 11 is a block diagram showing a specific configuration of the control portion shown in FIG. 10.

FIG. 12A is a graph showing a specific example of the power consumption characteristics that are corrected by the brightness determining portion shown in FIG. 11. FIG. 12B is a graph showing a specific example of the power consumption characteristics that are corrected again by the brightness determining portion shown in FIG. 11.

### DESCRIPTION OF THE INVENTION

Hereinafter, preferred embodiments of a display device and a television receiver of the present invention will be described with reference to the drawings. In the following description, the present invention is applied to a transmission type liquid crystal display device. The size and size ratio of each of the constituent members in the drawings do not exactly reflect those of the actual constituent members.

### Embodiment 1

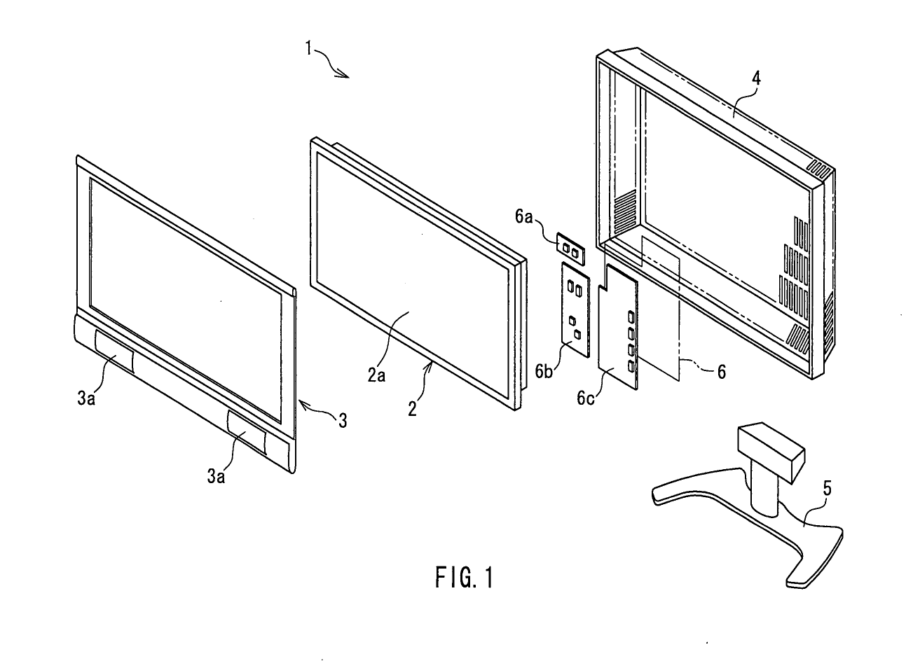

FIG. 1 is an exploded perspective view for explaining a television receiver and a liquid crystal display device according to Embodiment 1 of the present invention. In FIG. 1, a television receiver 1 of this embodiment includes a liquid crystal display device 2 as a display device and is configured to be able to receive television broadcasting with an antenna, a cable, etc. (not shown). The liquid crystal display device 2 is housed in a front cabinet 3 and a back cabinet 4, and placed upright on a stand 5. In the television receiver 1, a display surface 2a of the liquid crystal display device 2 can be viewed via the front cabinet 3. The display surface 2a is located parallel to the direction in which gravity acts (i.e., the vertical direction) by the stand 5.

In the television receiver 1, a tuner circuit board 6a, a control circuit board 6b for controlling each part of the television receiver 1, including a backlight device (as will be described later), and a power supply circuit board 6c are attached to a support plate 6 and interposed between the liquid crystal display device 2 and the back cabinet 4. In the television receiver 1, images in accordance with video signals of television broadcasting received by a tuner (as will be described later) on the tuner circuit board 6a are displayed on the display surface 2a, and sound is reproduced and output from speakers 3a provided in the front cabinet 3. The back cabinet 4 has many air holes through which heat generated in the backlight device or a power supply unit portion can escape.

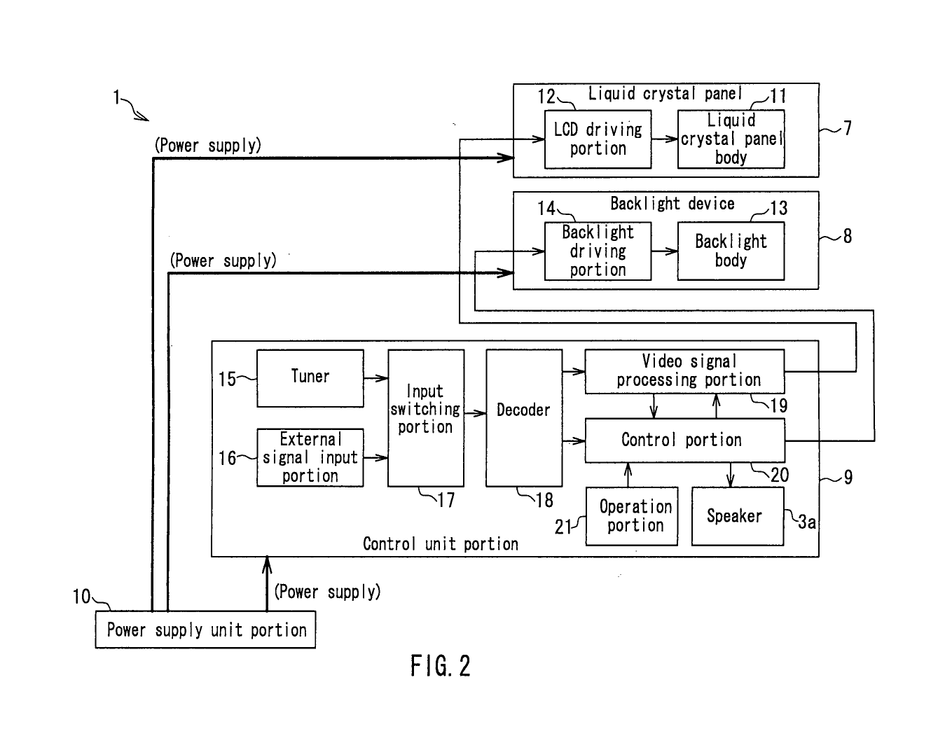

Next, the main configurations of the television receiver 1 and the liquid crystal display device 2 will be described in detail with reference to FIG. 2 as well.

FIG. 2 is a block diagram showing the main configurations of the television receiver and the liquid crystal display device.

In FIG. 2, the television receiver 1 includes a liquid crystal panel 7 (display portion) that displays information including characters and images, and a backlight device 8 (backlight portion) that emits illumination light to the liquid crystal panel 7. The liquid crystal panel 7 and the backlight device 8 are integrally assembled into the transmission-type liquid crystal display device 2. The liquid crystal panel 7 displays information with the use of the illumination light from the backlight device 8. The television receiver 1 also includes a control unit portion 9 that performs drive control of each part, and a power supply unit portion 10 that is connected to an AC power source or a DC power source, both of which are not shown, and supplies power to the liquid crystal panel 7, the backlight device 8, and the control unit portion 9.

The liquid crystal panel 7 includes a liquid crystal panel body 11 and an LCD driving portion 12. The liquid crystal panel body 11 has a plurality of pixels (not shown). The LCD driving portion 12 has a source driver and a gate driver, both of which are not shown, and drives the liquid crystal panel body 11 pixel by pixel. In the liquid crystal panel 7, an instruction signal from a video signal processing portion 19 included in the control unit portion 9 is input to the LCD driving portion 12, and the LCD driving portion 12 is configured to drive the liquid crystal panel body 11 based on the input instruction signal.

The liquid crystal panel 7 may have a desired liquid crystal mode or pixel structure. The liquid crystal panel 7 may also have a desired drive mode. That is, any liquid crystal panel capable of displaying information can be used as the liquid crystal panel 7. Therefore, the detailed structure of the liquid crystal panel 7 is not shown in the drawing, and the explanation thereof will be omitted.

The backlight device 8 includes a direct type backlight body 13 and a backlight driving portion 14. The backlight body 13 includes, e.g., a cold-cathode fluorescent tube as a light source. The backlight driving portion 14 includes an inverter circuit (not shown), and lights and drives the cold-cathode fluorescent tube using, e.g., PWM dimming. In the backlight device 8, an instruction signal from a control portion 20 included in the control unit portion 9 is input to the backlight driving portion 14, and the backlight driving portion 14 is configured to drive the backlight body 13 based on the input instruction signal. Moreover, the liquid crystal display device 2 has target power consumption and aims to reduce the power consumption, and also can prevent a viewer (user) from feeling uncomfortable with brightness changes, as will be described in detail later.

In the above description, the direct type backlight device 8 is used. However, this embodiment is not limited thereto, and may use an edge light type backlight device having a light guide plate. This embodiment may also use a backlight device that includes a light source such as a hot-cathode fluorescent tube or an LED other than the cold-cathode fluorescent tube.

The control unit portion 9 includes the tuner 15 for receiving video signals and sound signals of television broadcasting, and an external signal input portion 16 for receiving video signals and sound signals from external equipment such as a recording/reproducing apparatus (not shown). The control unit portion 9 also includes an input switching portion 17 and a decoder 18. The input switching portion 17 is connected to the tuner 15 and the external signal input portion 16, and performs input switching of the video signals and the sound signals from the tuner 15 and the external signal input portion 16. The decoder 18 is connected to the input switching portion 17, and performs a predetermined decoding operation on the video signals and the sound signals from the input switching portion 17.

Moreover, the control unit portion 9 includes the video signal processing portion 19, the control portion 20, and an operation portion 21. The video signal processing portion 19 is connected to the decoder 18, and performs predetermined picture processing such as scaling on the video signals from the input switching portion 17. The control portion 20 is connected to the decoder 18 and the video signal processing portion 19. The operation portion 21 includes a remote controller (not shown) and receives a viewer's operation (instruction). The video signal processing portion 19 produces an instruction signal for the source driver based on the video signals that have been subjected to the picture processing, and outputs the instruction signal to the control portion 20.

Not only the video signals and the sound signals from the decoder 18, but also operation/instruction signals from the operation portion 21 in response to the viewer's operation are input to the control portion 20. The control portion 20 is configured to perform drive control of each part based on the input operation/instruction signals. The control portion 20 outputs the sound signals from the decoder 18 to the speakers 3a, and then sound is output from the speakers 3a to the outside. Moreover, the control portion 20 is configured to perform drive control of the liquid crystal panel 7 and the backlight device 8 in accordance with the target power consumption when the target power consumption is set via the operation portion 21, as will be described in detail later. The video signal processing portion 19 and the control portion 20 are provided on the liquid crystal display device 2 side.

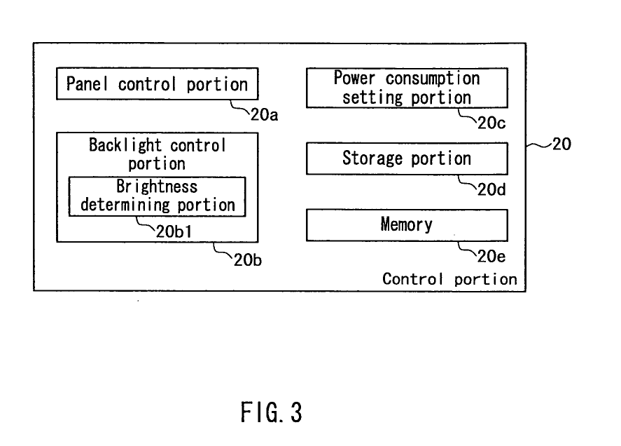

Next, the control portion 20 will be described in detail with reference to FIG. 3.

FIG. 3 is a block diagram showing a specific configuration of the control portion shown in FIG. 2.

As shown in FIG. 3, the control portion 20 includes a panel control portion 20a (display control portion) that performs drive control of the liquid crystal panel 7, and a backlight control portion 20b that performs drive control of the backlight device 8. The control portion 20 also includes a power consumption setting portion 20c, a storage portion 20d, and a memory 20e. The power consumption setting portion 20c sets the target power consumption as set power consumption. The storage portion 20d previously stores the power consumption characteristics that indicate the relationship between the video signal and the power consumption of the backlight device 8. The memory 20e previously stores the maximum power consumption of the liquid crystal panel 7.

The instruction signal for the source driver from the video signal processing portion 19 is input to the panel control portion 20a. The panel control portion 20a is configured to perform drive control of the liquid crystal panel 7 in accordance with the brightness of the illumination light that is determined by a brightness determining portion (as will be described later) provided in the backlight control portion 20b. Specifically, the panel control portion 20a corrects a (gradation) voltage signal for each pixel, i.e., the instruction signal for the source driver based on the determined brightness of the illumination light, outputs the corrected instruction signal to the video signal processing portion 19, and thus performs drive control of the liquid crystal panel 7.

The backlight control portion 20b is configured to perform drive control of the backlight device 8 using the input video signals, the set power consumption set by the power consumption setting portion 20c, and the power consumption characteristics stored in the storage portion 20d. Specifically, the backlight control portion 20b includes the brightness determining portion 20b1 that determines the brightness of the illumination light that is emitted from the backlight device 8 to the liquid crystal panel 7, produces an instruction signal for the backlight driving portion 14 in accordance with the brightness determined by the brightness determining portion 20b1, and outputs the instruction signal.

Based on the set power consumption set by the power consumption setting portion 20c and the maximum power consumption stored in the memory 20e, the brightness determining portion 20b1 corrects the power consumption characteristics stored in the storage portion 20d so that the power consumption of the backlight device 8 is not more than the set power consumption regardless of the input video signals, as will be described in detail later. Then, when the video signals are input from the decoder 18, the brightness determining portion 20b1 determines the brightness of the illumination light from the backlight device 8 using the input video signals and the corrected power consumption characteristics, and outputs an instruction signal to the backlight driving portion 14, as will be described in detail later.

The power consumption setting portion 20c sets the target power consumption as set power consumption based on the operation/instruction signals from the operation portion 21.

The storage portion 20d previously stores the power consumption characteristics that indicate the relationship between the video signal, e.g., an average picture level (APL) of the video signals per frame and the power consumption of the backlight device 8. The memory 20e previously stores the maximum power consumption of the liquid crystal panel 7.

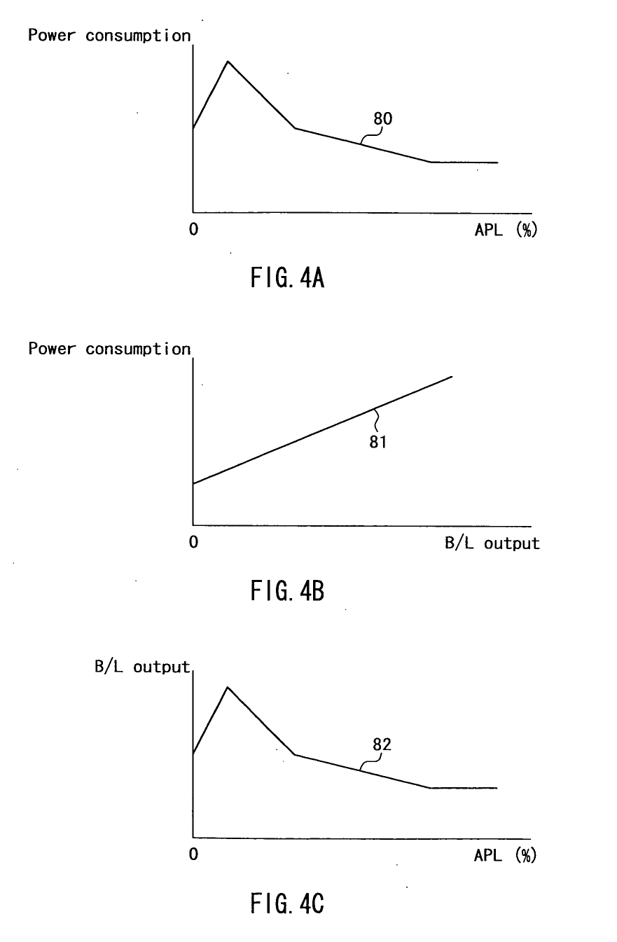

Hereinafter, the power consumption characteristics that are previously stored in the storage portion 20d will be described in detail with reference to FIGS. 4A to 4C.

FIG. 4A is a graph showing an example of the power consumption characteristics stored in the storage portion shown in FIG. 3. FIG. 4B is a graph showing a specific correlation example between the backlight output and the power consumption. FIG. 4C is a graph showing a specific correlation example between the average picture level (APL) and the backlight output.

In the storage portion 20d, the power consumption characteristics represented by a curve 80 in FIG. 4A are previously stored as a look up table (LUT). According to the power consumption characteristics, as indicated by the curve 80, the power consumption of the backlight device 8 can be obtained from the average picture level (APL) of the video signals per frame. Moreover, the power consumption of the backlight device 8 is uniquely determined by the output of the backlight device 8, i.e., the brightness of the illumination light from the backlight device 8. This is because the power consumption characteristics represented by the curve 80 are determined based on a straight line 81 in FIG. 4B and a curve 82 in FIG. 4C. In other words, there is a relationship represented by the straight line 81 between the output (i.e., the brightness of the illumination light) and the power consumption of the backlight device 8. In the liquid crystal display device 2, when the backlight control portion 20b performs APL-dependent drive control of the backlight device 8, there is a relationship represented by the curve 82 between the output of the backlight device 8 and the average picture level (APL). Since the power consumption characteristics are determined based on the straight line 81 and the curve 82, the power consumption (i.e., the brightness of the illumination light) of the backlight device 8 can be obtained from the average picture level (APL) by using the power consumption characteristics.

In addition to the above description, the characteristics represented by the straight line 81 and the curve 82 may be previously stored in the storage portion 20d as LUTs.

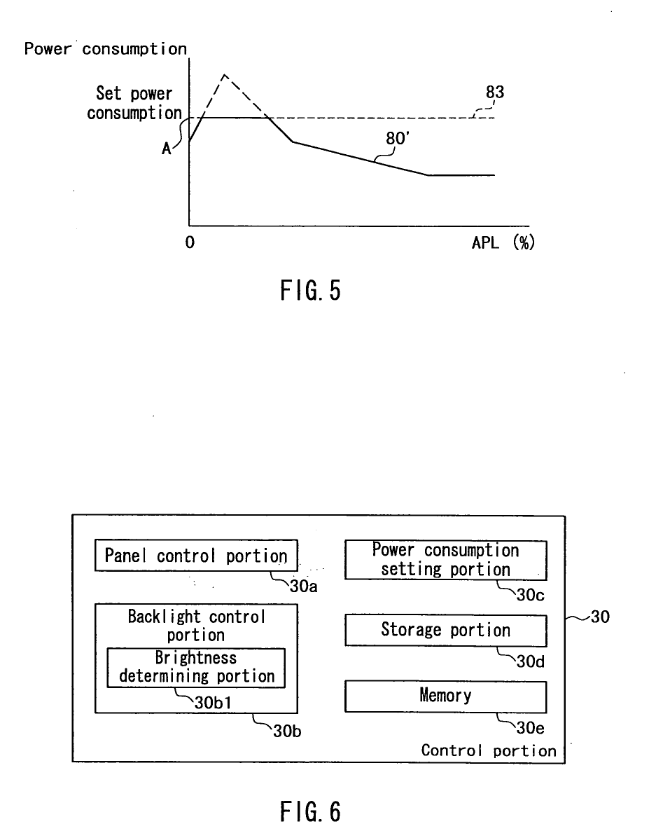

Hereinafter, the operation of the liquid crystal display device 2 having the above configuration of this embodiment will be described in detail with reference to FIG. 5 as well. The following mainly describes a brightness determining operation of the brightness determining portion 20b1 in the backlight control portion 20b.

FIG. 5 is a graph showing a specific example of the power consumption characteristics that are corrected by the brightness determining portion shown in FIG. 3.

Referring to FIG. 5, when the power consumption setting portion 20c sets the target power consumption (e.g., 60 W) as set power consumption, the brightness determining portion 20b1 in the backlight control portion 20b reads the maximum power consumption (e.g., 5 W) of the liquid crystal panel 7 that is stored in the memory 20e, and subtracts the maximum power consumption from the set power consumption. Then, the brightness determining portion 20b1 defines the result of the subtraction as new set power consumption A (e.g., 55 W) to be set by the power consumption setting portion 20c. Moreover, the brightness determining portion 20b1 corrects the power consumption characteristics represented by the curve 80 in FIG. 4A to those as represented by a curve 80′ in FIG. 5. That is, the brightness determining portion 20b1 corrects the power consumption characteristics represented by the curve 80 so that the power consumption of the backlight device 8 is not more than the set power consumption A (represented by a dotted line 83 in FIG. 5), and then stores the power consumption characteristics represented by the curve 80′ in the storage portion 20d.

Thereafter, when the video signals are input from the decoder 18, the brightness determining portion 20b1 obtains the power consumption of the backlight device 8 using the average picture level (APL) of the input video signals per frame and the power consumption characteristics represented by the curve 80′, thus determining the brightness of the illumination light. Subsequently, the brightness determining portion 20b1 produces an instruction signal for the backlight driving portion 14 based on the determined brightness of the illumination light, and outputs the instruction signal.

The liquid crystal display device 2 with the above configuration of this embodiment includes the power consumption setting portion 20c that sets the target power consumption as set power consumption, and the storage portion 20d that previously stores the power consumption characteristics that indicate the relationship between the video signal and the power consumption of the backlight device (backlight portion) 8. Moreover, the control portion 20 includes the backlight control portion 20b that performs drive control of the backlight device 8 using the input video signals, the set power consumption set by the power consumption setting portion 20c, and the power consumption characteristics stored in the storage portion 20d. Thus, unlike the conventional examples, the liquid crystal display device 2 of this embodiment can suppress an uncomfortable feeling caused by brightness changes even if the power consumption is reduced.

In the liquid crystal display device 2 of this embodiment, the brightness determining portion 20b1 in the backlight control portion 20b corrects the power consumption characteristics stored in the storage portion 20d based on the set power consumption set by the power consumption setting portion 20c and the maximum power consumption stored in the memory 20e. Moreover, as indicated by a solid line 80′ in FIG. 5, the brightness determining portion 20b1 corrects the power consumption characteristics so that the power consumption of the backlight device 8 is not more than the set power consumption A. Then, the brightness determining portion 20b1 determines the brightness of the illumination light from the backlight device 8 using the input video signals and the corrected power consumption characteristics. Thus, the liquid crystal display device 2 of this embodiment can reduce the power consumption reliably while ensuring that an uncomfortable feeling caused by brightness changes is suppressed.

The control portion 20 of the liquid crystal display device 2 of this embodiment includes the panel control portion (display control portion) 20a that performs drive control of the liquid crystal panel (display portion) 7 in accordance with the brightness of the illumination light that is determined by the brightness determining portion 20b1. Thus, the liquid crystal display device 2 of this embodiment can easily improve the display quality.

Since this embodiment uses the liquid crystal display device 2 that can suppress an uncomfortable feeling caused by brightness changes even if the power consumption is reduced, the television receiver 1 can easily achieve low power consumption, high performance, and excellent display quality.

In the above description, the maximum power consumption of the liquid crystal panel 7 is stored in the memory 20e, and the power consumption characteristics stored in the storage portion 20d are corrected using the maximum power consumption. However, this embodiment is not limited thereto. For example, average power consumption of the liquid crystal panel 7 may be stored in the memory 20e, and the power consumption characteristics stored in the storage portion 20d may be corrected using the average power consumption. Alternatively, the maximum power consumption or average power consumption of the control unit portion 9 other than the liquid crystal panel 7 may be stored in the memory 20e in order to correct the power consumption characteristics.

### Embodiment 2

FIG. 6 is a block diagram showing a specific configuration of a control portion of a liquid crystal display device according to Embodiment 2 of the present invention. In FIG. 6, this embodiment mainly differs from Embodiment 1 in that the brightness determining portion corrects the power consumption characteristics stored in the storage portion so that the maximum value of the power consumption of the backlight device is not more than the set power consumption set by the power consumption setting portion, and each value of the power consumption in the power consumption characteristics is reduced by a predetermined ratio. The same components as those of Embodiment 1 are denoted by the same reference numerals, and the explanation will not be repeated.

As shown in FIG. 6, a control portion 30 of this embodiment includes a panel control portion 30a that performs drive control of the liquid crystal panel 7, and a backlight control portion 30b that includes a brightness determining portion 30b1 and performs drive control of the backlight device 8. The control portion 30 also includes a power consumption setting portion 30c, a storage portion 30d, and a memory 30e. The power consumption setting portion 30c sets the target power consumption as set power consumption. The storage portion 30d previously stores the power consumption characteristics that indicate the relationship between the video signal and the power consumption of the backlight device 8. The memory 30e previously stores the maximum power consumption of the liquid crystal panel 7.

The brightness determining portion 30b1 of this embodiment is configured to correct the power consumption characteristics stored in the storage portion 30d so that the maximum value of the power consumption of the backlight device 8 is not more than the set power consumption set by the power consumption setting portion 30c, and each value of the power consumption in the power consumption characteristics is reduced by a predetermined ratio.

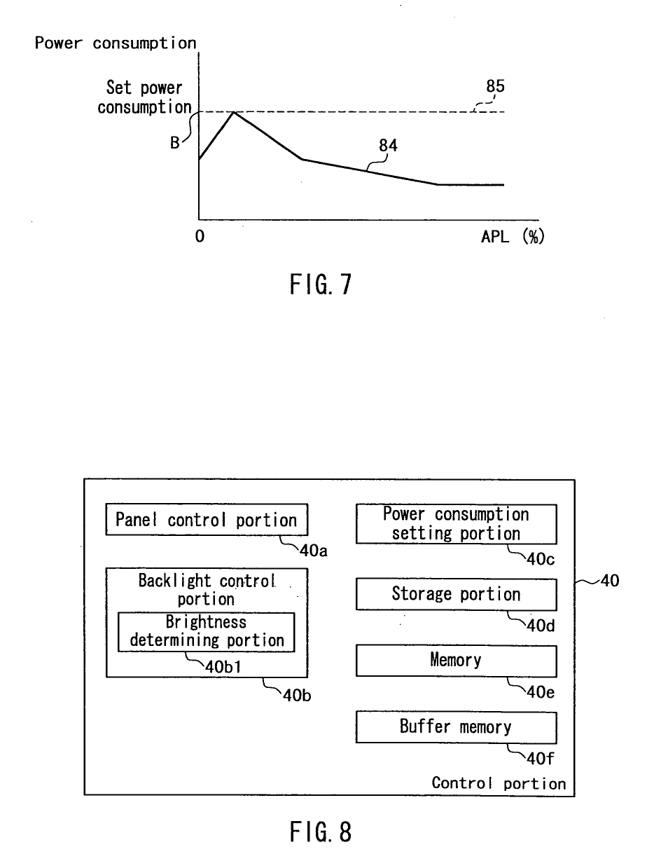

Next, the operation of the liquid crystal display device 2 of this embodiment will be described in detail with reference to FIG. 7 as well. The following mainly describes a brightness determining operation of the brightness determining portion 30b1 in the backlight control portion 30b.

FIG. 7 is a graph showing a specific example of the power consumption characteristics that are corrected by the brightness determining portion shown in FIG. 6.

Referring to FIG. 7, similarly to Embodiment 1, when the power consumption setting portion 30c sets the target power consumption (e.g., 60 W) as set power consumption, the brightness determining portion 30b1 in the backlight control portion 30b reads the maximum power consumption (e.g., 5 W) of the liquid crystal panel 7 that is stored in the memory 30e, and subtracts the maximum power consumption from the set power consumption. Then, the brightness determining portion 30b1 defines the result of the subtraction as new set power consumption B (e.g., 55 W) to be set by the power consumption setting portion 30c. Moreover, the brightness determining portion 30b1 corrects the power consumption characteristics represented by the curve 80 in FIG. 4A to those as represented by a curve 84 in FIG. 7. That is, the brightness determining portion 30b1 corrects the power consumption characteristics represented by the curve 80 so that the power consumption of the backlight device 8 is not more than the set power consumption B (represented by a dotted line 85 in FIG. 7), and each value of the power consumption in the power consumption characteristics represented by the curve 80 is reduced by a predetermined ratio, and then stores the power consumption characteristics represented by the curve 84 in the storage portion 30d.

Thereafter, when the video signals are input from the decoder 18, the brightness determining portion 30b1 obtains the power consumption of the backlight device 8 using the average picture level (APL) of the input video signals per frame and the power consumption characteristics represented by the curve 84, thus determining the brightness of the illumination light. Subsequently, the brightness determining portion 30b1 produces an instruction signal for the backlight driving portion 14 based on the determined brightness of the illumination light, and outputs the instruction signal.

With the above configuration, this embodiment can have similar operation and effect to those of Embodiment 1. In this embodiment, as indicated by a solid line 84 in FIG. 7, the brightness determining portion 30b1 corrects the power consumption characteristics so that the maximum value of the power consumption of the backlight device 8 is not more than the set power consumption B, and each value of the power consumption in the power consumption characteristics is reduced by a predetermined ratio. Thus, this embodiment can reduce the power consumption more reliably while suppressing an uncomfortable feeling caused by brightness changes.

Other than the above description, a plurality of corrected power consumption characteristics corresponding to each of a plurality of set power consumption may be previously stored in the storage portion 30d, and the brightness determining portion 30b1 may use any of the corrected power consumption characteristics in accordance with the set power consumption when the set power consumption is determined.

### Embodiment 3

FIG. 8 is a block diagram showing a specific configuration of a control portion of a liquid crystal display device according to Embodiment 3 of the present invention. In FIG. 8, this embodiment mainly differs from Embodiment 2 in that the brightness determining portion uses a plurality of frames of video signals stored in a buffer memory to correct the power consumption characteristics again, which have been already corrected based on the set power consumption set by the power consumption setting portion, and determines the brightness of the illumination light using the input video signals and the twice-corrected power consumption characteristics. The same components as those of Embodiment 2 are denoted by the same reference numerals, and the explanation will not be repeated.

As shown in FIG. 8, a control portion 40 of this embodiment includes a panel control portion 40a that performs drive control of the liquid crystal panel 7, and a backlight control portion 40b that includes a brightness determining portion 40b1 and performs drive control of the backlight device 8. The control portion 40 also includes a power consumption setting portion 40c, a storage portion 40d, and a memory 40e. The power consumption setting portion 40c sets the target power consumption as set power consumption. The storage portion 40d previously stores the power consumption characteristics that indicate the relationship between the video signal and the power consumption of the backlight device 8. The memory 40e previously stores the maximum power consumption of the liquid crystal panel 7. Moreover, the control portion 40 includes a buffer memory 40f that stores a plurality of frames of video signals input from the decoder 18.

The brightness determining portion 40b1 of this embodiment is configured to use the plurality of frames of video signals stored in the buffer memory 40f to correct the power consumption characteristics again, which have been already corrected based on the set power consumption, and determine the brightness of the illumination light using the input video signals and the twice-corrected power consumption characteristics.

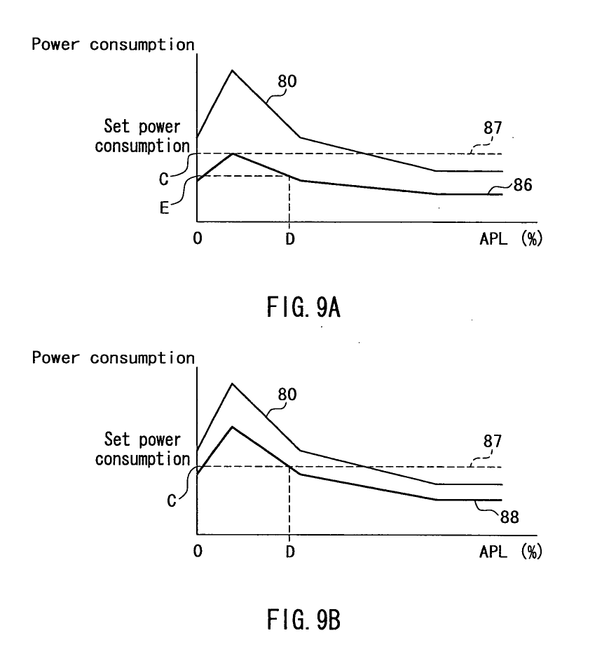

Next, the operation of the liquid crystal display device 2 of this embodiment will be described in detail with reference to FIGS. 9A and 9B as well. The following mainly describes a brightness determining operation of the brightness determining portion 40b1 in the backlight control portion 40b.

FIG. 9A is a graph showing a specific example of the power consumption characteristics that are corrected by the brightness determining portion shown in FIG. 8. FIG. 9B is a graph showing a specific example of the power consumption characteristics that are corrected again by the brightness determining portion shown in FIG. 8.

Referring to FIG. 9A, similarly to Embodiment 2, when the power consumption setting portion 40c sets the target power consumption (e.g., 60 W) as set power consumption, the brightness determining portion 40b1 in the backlight control portion 40b reads the maximum power consumption (e.g., 5 W) of the liquid crystal panel 7 that is stored in the memory 40e, and subtracts the maximum power consumption from the set power consumption. Then, the brightness determining portion 40b1 defines the result of the subtraction as new set power consumption C (e.g., 55 W) to be set by the power consumption setting portion 40c. Moreover, the brightness determining portion 40b1 corrects the power consumption characteristics represented by the curve 80 in FIG. 9A (FIG. 4A) to those as represented by a curve 86 in FIG. 9A. That is, the brightness determining portion 40b1 corrects the power consumption characteristics represented by the curve 80 so that the power consumption of the backlight device 8 is not more than the set power consumption C (represented by a dotted line 87 in FIG. 9A), and each value of the power consumption in the power consumption characteristics represented by the curve 80 is reduced by a predetermined ratio, and then stores the power consumption characteristics represented by the curve 86 in the storage portion 40d.

Next, when the video signals are input from the decoder 18, the brightness determining portion 40b1 obtains the power consumption of the backlight device 8 using the average picture level (APL) of the input video signals per frame and the power consumption characteristics represented by the curve 86, thus determining the brightness of the illumination light. Subsequently, the brightness determining portion 40b1 produces an instruction signal for the backlight driving portion 14 based on the determined brightness of the illumination light, and outputs the instruction signal.

Thereafter, when the plurality of frames of video signals are held in the buffer memory 40f, the brightness determining portion 40b1 obtains an average value (represented by a point D in FIG. 9A) of the average picture levels (APLs) of the plurality of frames of video signals held in the buffer memory 40f. Then, the brightness determining portion 40b1 determines a value E of the power consumption corresponding to the average value D from the power consumption characteristics represented by the curve 86. Next, the brightness determining portion 40b1 corrects the power consumption characteristics represented by the curve 86 so that a difference between the value E of the power consumption and the set power consumption C is zero, i.e., the power consumption corresponding to the average value D is equal to the set power consumption C. Consequently, the power consumption characteristics represented by the curve 86 are corrected to those represented by a curve 88 in FIG. 9B. Then, the power consumption characteristics represented by the curve 88 are stored in the storage portion 40d.

Next, when the video signals are input from the decoder 18, the brightness determining portion 40b1 obtains the power consumption of the backlight device 8 using the average picture level (APL) of the input video signals per frame and the power consumption characteristics represented by the curve 88, thus determining the brightness of the illumination light. Subsequently, the brightness determining portion 40b1 produces an instruction signal for the backlight driving portion 14 based on the determined brightness of the illumination light, and outputs the instruction signal.

With the above configuration, this embodiment can have similar operation and effect to those of Embodiment 2. In this embodiment, as indicated by the curve 88 in FIG. 9B, the brightness determining portion 40b1 uses the plurality of frames of video signals stored in the buffer memory 40f to correct the power consumption characteristics again, which have been already corrected based on the set power consumption, and determines the brightness of the illumination light using the input video signals and the twice-corrected power consumption characteristics. Thus, this embodiment can improve the brightness in accordance with the video signals that are actually displayed.

Other than the above description, EPG (electronic program guide) information may be used to correct the power consumption characteristics again, which have been already corrected based on the set power consumption set by the power consumption setting portion 40c. Specifically, the program genre is previously linked to the average picture level (APL), and then held in the storage device. When a viewer (user) selects a program, the program genre is acquired from the EPG information based on the selected program, and further the average picture level is acquired. This average picture level may be used to correct the power consumption characteristics again, which have been already corrected based on the set power consumption set by the power consumption setting portion 40c. With this configuration, the placement of the buffer memory 40f can be omitted.

Other than the above description, e.g., only the average picture levels (APLs) of the plurality of frames of video signals may be stored in the buffer memory 40f. With this configuration, the storage capacity of the buffer memory 40f can be reduced.

### Embodiment 4

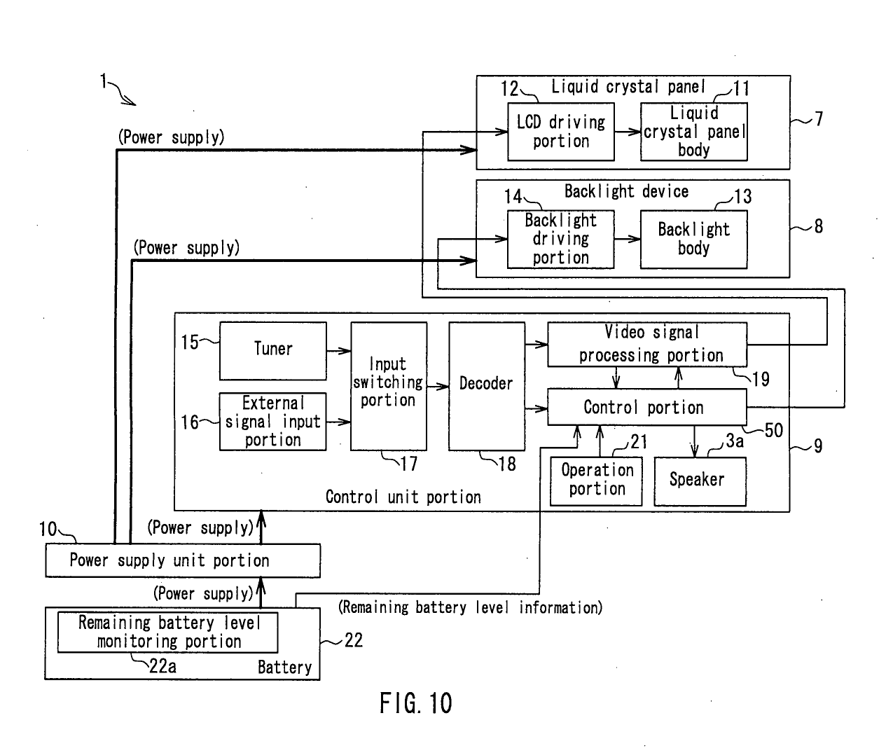

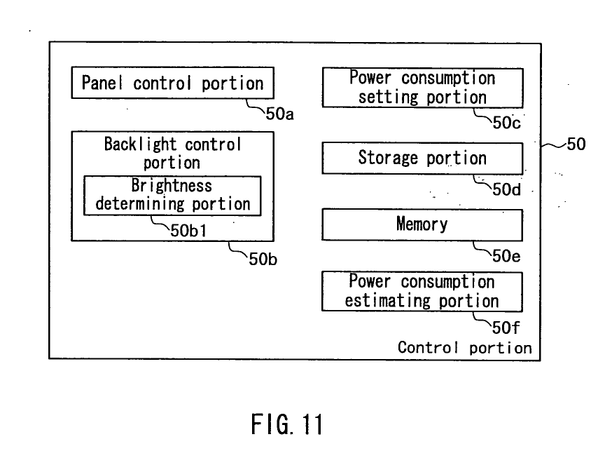

FIG. 10 is a block diagram showing the main configuration of a television receiver according to Embodiment 4 of the present invention. FIG. 11 is a block diagram showing a specific configuration of the control portion shown in FIG. 11. In FIGS. 10 and 11, this embodiment mainly differs from Embodiment 2 in the following points. First, a battery and a power consumption estimating portion are provided. The battery includes a remaining battery level monitoring portion. The power consumption estimating portion estimates the amount of power consumption for a predetermined time using the predetermined time that is previously set and the set power consumption set by the power consumption setting portion. Second, when the remaining amount of the battery is found to be smaller than the estimated amount of power consumption, the brightness determining portion corrects the power consumption characteristics stored in the storage portion so that the amount of power consumption for the predetermined time is not more than the remaining amount of the battery, and determines the brightness of the illumination light using the input video signals and the corrected power consumption characteristics. The same components as those of Embodiment 2 are denoted by the same reference numerals, and the explanation will not be repeated.

As shown in FIG. 10, in a television receiver 1 of this embodiment, a battery 22 capable of charging and discharging electricity is provided on the liquid crystal display device 2 side and supplies power to the power supply unit portion 10. The battery 22 includes a remaining battery level monitoring portion 22a that monitors the remaining amount of the battery 22 and outputs the remaining battery level information that indicates the monitored remaining amount of the battery 22 to a control portion (outside) 50.

As shown in FIG. 11, the control portion 50 of this embodiment includes a panel control portion 50a that performs drive control of the liquid crystal panel 7, and a backlight control portion 50b that includes a brightness determining portion 50b1 and performs drive control of the backlight device 8. The control portion 50 also includes a power consumption setting portion 50c, a storage portion 50d, and a memory 50e. The power consumption setting portion 50c sets the target power consumption as set power consumption. The storage portion 50d previously stores the power consumption characteristics that indicate the relationship between the video signal and the power consumption of the backlight device 8. The memory 50e previously stores the maximum power consumption of the liquid crystal panel 7. Moreover, the control portion 50 includes a power consumption estimating portion 50f that estimates the amount of power consumption for a predetermined time (e.g., 1 hour) using the predetermined time that is previously set and the set power consumption set by the power consumption setting portion 50c.

The brightness determining portion 50b1 of this embodiment compares the remaining amount of the battery 22 indicated by the remaining battery level information from the remaining battery level monitoring portion 22a and the amount of power consumption estimated by the power consumption estimating portion 50f. When the comparison shows that the remaining amount of the battery 22 is smaller than the estimated amount of power consumption, the brightness determining portion 50b1 is configured to correct the power consumption characteristics stored in the storage portion 50d so that the amount of power consumption for the predetermined time is not more than the remaining amount of the battery 22, and determine the brightness of the illumination light using the input video signals and the corrected power consumption characteristics.

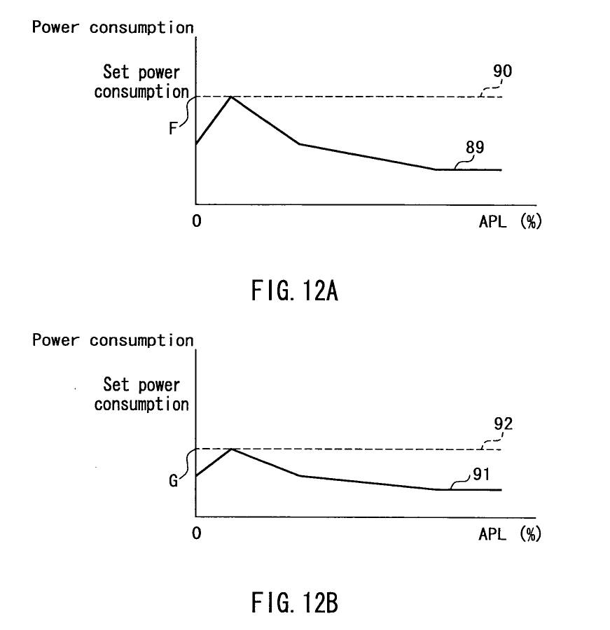

Next, the operation of the liquid crystal display device 2 of this embodiment will be described in detail with reference to FIGS. 12A and 12B as well. The following mainly describes a brightness determining operation of the brightness determining portion 50b1 in the backlight control portion 50b.

FIG. 12A is a graph showing a specific example of the power consumption characteristics that are corrected by the brightness determining portion shown in FIG. 11. FIG. 12B is a graph showing a specific example of the power consumption characteristics that are corrected again by the brightness determining portion shown in FIG. 11.

Referring to FIG. 12A, similarly to Embodiment 2, when the power consumption setting portion 50c sets the target power consumption (e.g., 60 W) as set power consumption, the brightness determining portion 50b1 in the backlight control portion 50b reads the maximum power consumption (e.g., 5 W) of the liquid crystal panel 7 that is stored in the memory 50e, and subtracts the maximum power consumption from the set power consumption. Then, the brightness determining portion 50b1 defines the result of the subtraction as new set power consumption F (e.g., 55 W) to be set by the power consumption setting portion 50c. Moreover, the brightness determining portion 50b1 corrects the power consumption characteristics represented by the curve 80 in FIG. 4A to those as represented by a curve 89 in FIG. 12A. That is, the brightness determining portion 50b1 corrects the power consumption characteristics represented by the curve 80 so that the power consumption of the backlight device 8 is not more than the set power consumption F (represented by a dotted line 90 in FIG. 12A), and each value of the power consumption in the power consumption characteristics represented by the curve 80 is reduced by a predetermined ratio, and then stores the power consumption characteristics represented by the curve 89 in the storage portion 50d.

In the control portion 50, the power consumption estimating portion 50f estimates the amount of power consumption for a predetermined time (e.g., 1 hour) using the predetermined time that is previously set and the set power consumption F set by the power consumption setting portion 50c. Then, the power consumption estimating portion 50f outputs the estimated amount of power consumption to the brightness determining portion 50b1. Moreover, the remaining battery level information from the remaining battery level monitoring portion 22a is input every predetermined time to the brightness determining portion 50b1. Thus, the brightness determining portion 50b1 compares the remaining amount of the battery 22 indicated by the remaining battery level information and the amount of power consumption estimated by the power consumption estimating portion 50f. When the comparison shows that the remaining amount of the battery 22 is smaller than the estimated amount of power consumption, the brightness determining portion 50b1 corrects the power consumption characteristics stored in the storage portion 50d so that the amount of power consumption for the predetermined time is not more than the remaining amount of the battery 22.

Specifically, the brightness determining portion 50b1 obtains new set power consumption G at which the amount of power consumption for the predetermined time is not more than the remaining amount of the battery 22. Moreover, the brightness determining portion 50b1 corrects the power consumption characteristics represented by the curve 80 so that the power consumption of the backlight device 8 is not more than the set power consumption G (represented by a dotted line 92 in FIG. 12B), and each value of the power consumption in the power consumption characteristics represented by the curve 80 is reduced by a predetermined ratio, and then obtains the power consumption characteristics represented by a curve 91 in FIG. 12B and stores them in the storage portion 50d.

Thereafter, when the video signals are input from the decoder 18, the brightness determining portion 50b1 obtains the power consumption of the backlight device 8 using the average picture level (APL) of the input video signals per frame and the power consumption characteristics represented by the curve 91, thus determining the brightness of the illumination light. Subsequently, the brightness determining portion 50b1 produces an instruction signal for the backlight driving portion 14 based on the determined brightness of the illumination light, and outputs the instruction signal.

With the above configuration, this embodiment can have similar operation and effect to those of Embodiment 2. This embodiment uses the battery 22 that includes the remaining battery level monitoring portion 22a, and the power consumption estimating portion 50f that estimates the amount of power consumption for a predetermined time. In this embodiment, the brightness determining portion 50b1 compares the remaining amount of the battery 22 indicated by the remaining battery level information from the remaining battery level monitoring portion 22a and the amount of power consumption estimated by the power consumption estimating portion 50f. When the comparison shows that the remaining amount of the battery 22 is smaller than the amount of power consumption, the brightness determining portion 50b1 corrects the power consumption characteristics stored in the storage portion 50d so that the amount of power consumption for the predetermined time is not more than the remaining amount of the battery 22, as indicated by the curve 91 in FIG. 12B, and determines the brightness of the illumination light using the input video signals and the corrected power consumption characteristics. Thus, in this embodiment, the liquid crystal display device 2 including the battery 22 can suppress an uncomfortable feeling caused by brightness changes even if the power consumption is reduced.

It should be noted that the above embodiments are all illustrative and not restrictive. The technological scope of the present invention is defined by the appended claims, and all changes that come within the range of equivalency of the claims are intended to be embraced therein.

For example, in the above description, the present invention is applied to the transmission type liquid crystal display device. However, the display device of the present invention is not limited thereto, and may be applied to various display devices including a non-luminous display portion that utilizes light from the backlight device to display information such as images and characters. Specifically, the display device of the present invention can be suitably used in a semi-transmission type liquid crystal display device or a projection type display device using a liquid crystal panel as a light valve.

In the above description, the power consumption setting portion is provided in the control portion. However, there is no particular limitation to the present invention as long as it includes the power consumption setting portion that sets the target power consumption as set power consumption and the storage portion that previously stores the power consumption characteristics that indicate the relationship between the video signal and the power consumption of the backlight device, and the control portion includes the backlight control portion that performs drive control of the backlight portion using the input video signals, the set power consumption set by the power consumption setting portion, and the power consumption characteristics stored in the storage portion.

In the above description, the brightness determining portion corrects the power consumption characteristics stored in the storage portion based on the set power consumption set by the power consumption setting portion and the maximum power consumption stored in the memory However, the brightness determining portion of the present invention is not particularly limited as long as it corrects the power consumption characteristics stored in the storage portion based on the set power consumption set by the power consumption setting portion.

As described in each of the above embodiments, it is preferable that the brightness determining portion also uses the maximum power consumption stored in the memory to correct the power consumption characteristics, since an appropriate reduction in power consumption can be more easily achieved.

In the above description, the storage portion previously stores the power consumption characteristics that relate the average picture level (APL) of the video signals per frame to the power consumption of the backlight portion, and the power consumption characteristics are used to perform drive control of the backlight portion. However, the present invention is not limited thereto, and may use the power consumption characteristics that relate the other feature amount of the video signals to the power consumption of the backlight portion. Specifically, the maximum picture level of the video signals per frame may be related to the power consumption of the backlight portion, and then previously stored in the storage portion as power consumption characteristics, and the power consumption characteristics may be used to perform drive control of the backlight portion.

As described in each of the above embodiments, it is preferable that the average picture level of the video signals per frame is used for the power consumption characteristics, since the drive control of the backlight portion can be properly performed in accordance with the video signals.

In the above description, the power consumption setting portion sets the power consumption (e.g., 60 W) as set power consumption. However, the power consumption setting portion of the present invention is not limited thereto, and may set, e.g., the amount of power consumption and the viewing time (e.g., 120 Wh and 2 hours) as set power consumption.

In the above description of Embodiment 4, the remaining battery level monitoring portion is provided in the battery. However, the present invention is not limited thereto. For example, the remaining battery level monitoring portion may be provided in the power supply unit portion or the control portion to produce the remaining battery level information that indicates the remaining amount of the battery.

### INDUSTRIAL APPLICABILITY

The present invention is useful for a display device that can suppress an uncomfortable feeling caused by brightness changes even if the power consumption is reduced, and a television receiver using the display device.

### DESCRIPTION OF REFERENCE NUMERALS

1 Television receiver

2 Liquid crystal display device (display device)

7 Liquid crystal panel (display portion)

8 Backlight device (backlight portion)

20, 30, 40, 50 Control portion

20a, 30a, 40a, 50a Panel control portion (display control portion)

20b, 30b, 40b, 50b Backlight control portion

20b1, 30b1, 40b1, 50b1 Brightness determining portion

20c, 30c, 40c, 50c Power consumption setting portion

20d, 30d, 40d, 50d Storage portion

20e, 30e, 40e, 50e Memory

40f Buffer memory

50f Power consumption estimating portion

22 Battery

22a Remaining battery level monitoring portion

1. A display device comprising:
a backlight portion; and
a display portion that displays information using illumination light from the backlight portion,
wherein the display device further comprises:
a control portion that receives a video signal from outside and performs drive control of the backlight portion and the display portion using the input video signal;
a power consumption setting portion that sets target power consumption as set power consumption; and
a storage portion that previously stores power consumption characteristics that indicate a relationship between the video signal and power consumption of the backlight portion, and
wherein the control portion includes a backlight control portion that performs drive control of the backlight portion using the input video signal, the set power consumption set by the power consumption setting portion, and the power consumption characteristics stored in the storage portion.

2. The display device according to claim 1, wherein the backlight control portion includes a brightness determining portion that corrects the power consumption characteristics stored in the storage portion based on the set power consumption set by the power consumption setting portion, and determines brightness of the illumination light using the input video signal and the corrected power consumption characteristics.

3. The display device according to claim 2, wherein the brightness determining portion corrects the power consumption characteristics stored in the storage portion so that the power consumption of the backlight portion is not more than the set power consumption set by the power consumption setting portion.

4. The display device according to claim 2, wherein the brightness determining portion corrects the power consumption characteristics stored in the storage portion so that a maximum value of the power consumption of the backlight portion is not more than the set power consumption set by the power consumption setting portion, and each value of the power consumption in the power consumption characteristics is reduced by a predetermined ratio.

5. The display device according to claim 2, further comprising a buffer memory that stores a plurality of frames of video signals,
wherein the brightness determining portion uses the video signals stored in the buffer memory to correct the power consumption characteristics again, which have been already corrected based on the set power consumption set by the power consumption setting portion, and determines brightness of the illumination light using the input video signal and the twice-corrected power consumption characteristics.

6. The display device according to claim 2, further comprising:
a battery capable of charging and discharging electricity; and
a remaining battery level monitoring portion that monitors a remaining amount of the battery and outputs remaining battery level information that indicates the monitored remaining amount of the battery to outside,
wherein the control portion includes a power consumption estimating portion that estimates an amount of power consumption for a predetermined time using the predetermined time that is previously set and the set power consumption set by the power consumption setting portion, and
the brightness determining portion compares the remaining amount of the battery indicated by the remaining battery level information from the remaining battery level monitoring portion and the amount of power consumption estimated by the power consumption estimating portion, and when the comparison shows that the remaining amount of the battery is smaller than the amount of power consumption, the brightness determining portion corrects the power consumption characteristics stored in the storage portion so that the amount of power consumption for the predetermined time is not more than the remaining amount of the battery, and determines brightness of the illumination light using the input video signal and the corrected power consumption characteristics.

7. The display device according to claim 2, wherein the control portion includes a display control portion that performs drive control of the display portion in accordance with the brightness of the illumination light determined by the brightness determining portion.

8. The display device according to claim 2, further comprising a memory that previously stores maximum power consumption of the display portion,
wherein the brightness determining portion corrects the power consumption characteristics stored in the storage portion based on the set power consumption set by the power consumption setting portion and the maximum power consumption stored in the memory, and determines brightness of the illumination light using the input video signal and the corrected power consumption characteristics.

9. The display device according to claim 1, wherein the storage portion previously stores the power consumption characteristics that relate an average picture level of the video signals per frame to the power consumption of the backlight portion, and
the backlight control portion performs drive control of the backlight portion using the average picture level of the input video signals per frame, the set power consumption set by the power consumption setting portion, and the power consumption characteristics stored in the storage portion.

10. A television receiver comprising the display device according claim 1.
